(19) United States
(12) Patent Application Publication
(10) Pub. No.: US 2008/0193823 A1
(43) Pub. Date: Aug. 14, 2008

(54) Connection Structure of Fuel Cartridge for Fuel Cell

(76) Inventor: Minoru Kanno, Shizuoka (JP)

Correspondence Address: TROJAN LAW OFFICES, 9250 WILSHIRE BLVD, SUITE 325, BEVERLY HILLS, CA, 90212, US

(21) Appl. No.: 11/572,210

(22) PCT Filed: Jul. 12, 2005
(86) PCT No.: PCT/JP2005/013212

§ 371 Date: Jan. 16, 2008

(30) Foreign Application Priority Data
Jul. 16, 2004 (JP) 2004-210816
Jul. 20, 2004 (JP) 2004-212079

(51) Int. Cl. H01M 8/04; B65D 83/00; F16L 25/00

(52) U.S. Cl. 429/34; 285/328

(57) ABSTRACT

Erroneous installation of fuel cell fuel cartridges, in which different kinds of fuels are received, on an apparatus is prevented The fuel cell fuel cartridge has a container body (2) that is provided with a fuel supply opening (10) for supplying a fuel and with a connecting circular tube body (20) surrounding the fuel supply opening (10) and has a fuel storage chamber that is formed inside the container body (2) to receive the liquid fuel to be supplied to a fuel cell. The shape of the circular tube body (20) varies according to the kind of fuel stored in the fuel storage chamber.

### INDUSTRIAL FIELD

The present invention relates to a structure used to connect to a device a cartridge for fuel cell which is used to supply gaseous and liquefied fuel to a fuel cell.

### BACKGROUND OF THE INVENTION

Although fuel cells are being studied as small-scale power sources for personal computers (notebook computers, PDA and the like) and other small-scale devices, fuel cartridges which supply fuel to these fuel cells is required for these.

This fuel cartridge is provided with (a) a container main body which itself is provided with (i) a fuel supply opening which faces outward; and (ii) a connection cylindrical body which surrounds this fuel supply opening; and (b) a fuel storage chamber which is used to store the liquefied fuel which is supplied to the fuel cell.

Incidentally, fuels such as methanol and a variety of other fuels which different constituents are used as the aforementioned fuel. The fuels used may have the same constituents but different concentrations and they may also be pressurized. As a result, it is possible that fuels with different constituents may be supplied to the fuel cell. For this reason, a reference groove is disposed to prevent the cartridge from being erroneously connected to a device. Nevertheless, the orientation is mainly determined in this case and there have been problems in that the type of connection pattern which can be used is limited and a large number of combinations cannot be made.

### DISCLOSURE OF INVENTION

The connection structure for fuel cartridge for fuel cell in the present invention is a connection structure which is used to connect (a) a container main body which is provided with (i) a fuel supply opening with is used to supply fuel and (i) a connection protrusion body which surrounds this fuel supply opening; (b) a fuel cell fuel cartridge which is provided with a fuel storage chamber which is formed on the inside of the container main body which stores the fuel supplied to the fuel cell; and (c) a fuel cell device which is provided with a connection part which corresponds to the aforementioned connection protrusion device, the structure being configured of

a reference protrusion or reference groove which is used at an absolute position is formed on the aforementioned connection protruding body and one or more selection protrusions on selection grooves are formed at relatively different positions according to the type of fuel used relative to the reference protrusion or reference groove;

a device-side reference groove or device-side reference protrusion which corresponds to the aforementioned reference protrusion or reference groove and a device-side selection groove or device-side reference protrusion are formed on the connection part of the aforementioned fuel cell device;

and it is configured so that the aforementioned fuel cartridge can be inserted as far as an indicated position when the aforementioned fuel supply opening opens only when the aforementioned reference protrusion or reference groove interlocks with the aforementioned reference groove on the device side or the reference protrusion on the device side and only when the reference protrusion or reference groove on the aforementioned connection protrusion body interlocks with the aforementioned selection groove on the device side or the selection protrusion on the device side.

The aforementioned types of fuel include the constituents, concentration and pressure of the fuel.

The reference protrusion or reference groove on the aforementioned fuel cartridge should be longer than the aforementioned selection protrusion or selection groove. Or the aforementioned reference protrusion or reference groove should be wider or deeper than the aforementioned selection protrusion or selection groove.

The same color for different types of fuel should be placed on at least one part of the aforementioned fuel cartridge and at least one part of the aforementioned fuel cell device.

In addition, the fuel cell cartridge in the present invention is provided with (a) a container main body which itself is provided with (i) a fuel supply opening which is used to supply the fuel and (ii) a connection protrusion body which surrounds the fuel supply opening; and (b) a fuel storage chamber which is formed inside the container main body part which stores the fuel to be supplied to the fuel cell; the invention characterized as having

a reference protrusion or reference groove, which is the standard for the absolute position, is formed on the aforementioned connection protrusion body and one or more selection protrusions or selection grooves are formed at different positions depending on the type of fuel used relatively to the reference protrusion or reference groove.

In this case, this should be at least part of the aforementioned container main body and different colors—according to the type of fuel used—should be placed at positions which are readily visible from the outside.

The connection structure for fuel cartridge for fuel cell in the present invention is characterized as having a reference protrusion or reference groove corresponding to the device side reference groove or device side reference protrusion device side—which is provided with a connection part for the fuel cell device—which is formed on the connection protrusion body of the fuel cartridge, and a reference protrusion or reference groove corresponding to the device selection groove or device selection protrusion at different position according to the type of fuel used, itself being provided with a fuel cell device, it also being formed on the connection protrusion body of the fuel cartridge. As a result, it is easy to position these and a fuel cartridge in which different types of fuel are stored cannot be installed on the fuel cell device thereby preventing erroneous installation.

In particular, when the width and/or depth of the reference protrusion or reference groove of the fuel cartridge is broader and deeper than the width of the selection protrusion or selection groove, there is no interlocking with a part other than the reference groove even if the user unconsciously tries to connect it. As a result, the fuel opening does not open when connection is not complete thereby ensuring safety.

In addition, even when the reference groove is made longer than the reference groove, the device side selection protrusion is formed at a position where it interlocks with the selection groove on the cartridge side midway in the insertion stroke for the connection protrusion body. As a result, only the reference groove is inserted so that the fuel cartridge which stores different types of fuel is such that only the reference groove is inserted at mid-point. As a result, it is not installed on the device and the fuel supply opening does not open thereby ensuring safety.

The present invention is also useful in that a large number of patterns may be selected for combination with the selection protrusion or selection groove. By providing the fuel cell device side and the fuel cartridge side with the same color according to the type of fuel used, the user can easily recognize these.

### BRIEF EXPLANATION OF FIGURES

FIG. 1 is a center sectional frontal view of an example of the fuel cartridge for fuel cell in the present invention.

FIG. 2 is an inclined view of a first mode for working of the fuel cartridge for fuel cell in the present invention.

FIG. 3 is an inclined view of a second mode for working of the fuel cartridge for fuel cell in the present invention.

FIG. 4 is an inclined view of a third mode for working of the fuel cartridge for fuel cell in the present invention.

FIG. 5 is an inclined view of a fourth mode for working of the fuel cartridge for fuel cell in the present invention.

FIG. 6 is an inclined view of a fifth mode for working of the fuel cartridge for fuel cell in the present invention.

FIG. 7 is an inclined view of a sixth mode for working of the fuel cartridge for fuel cell in the present invention.

FIG. 8 is an inclined view of a seventh mode for working of the fuel cartridge for fuel cell in the present invention.

### BEST MODE FOR WORKING THE PRESENT INVENTION

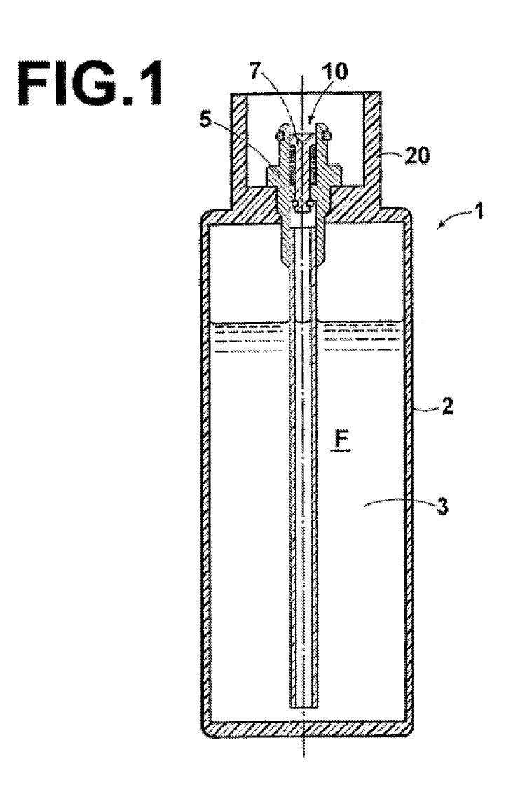

Next, we shall describe a mode of working of the present invention referring to figures. FIG. 1 is a center sectional frontal view of an example of the fuel cartridge for fuel cell to which the present invention is applied.

The fuel cartridge for fuel cell in FIG. 1 is used to store the fuel F for fuel cell and supplies fuel directly to the fuel cell device (not shown in figure) or via a pressure adjustor.

This fuel cartridge is provided with (a) a nozzle 5 which itself is provided with a fuel connection opening 10 used to supply the fuel; (b) a container main body 2 which itself is provided with a connection cylindrical body 20 which surrounds this fuel supply opening 10; and (c) a fuel storage chamber 3 which is formed on the inside of the container main body 2 which stores the fuel F which is supplied to the fuel cell. A valve 7 is disposed inside nozzle 5.

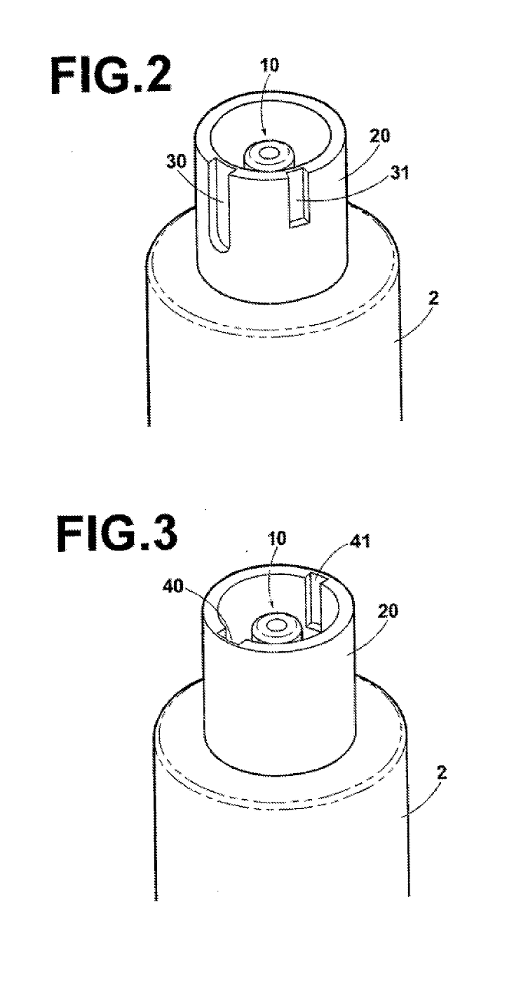

FIG. 2 is an inclined view of the first mode for working of the present invention. A reference groove 30—which is a standard for an absolute position and which extends from the end of the cylindrical body 20 in the direction of installation of cylindrical body 20—is formed on one location on the outer periphery of the cylindrical body 20 which itself is a connection protrusion body. Then, as many selection grooves 31 (in this case, 1) as are preset for the different types of fuel (in this case) extend at a position which has been preset in the direction of installation of the cylindrical body 20 from the end of cylindrical body 20. The aforementioned reference groove 30 is made so that it is broader than the width of the selection groove 31 and deeper than the groove as well.

Meanwhile, a device-side reference protrusion corresponding to the aforementioned reference groove 30 and a device-side selection protrusion corresponding to the aforementioned selection groove 31 are formed on the connection part of the fuel cell device (not shown in figure). Then this device-side selection protrusion is formed so that it interlocks with the selection groove 31 midway from the insertion stroke of the cylindrical body 20.

The aforementioned reference groove 30 is made broader than the width of and deeper than the selection groove 31. In keeping with this, the device-side reference protrusion too is made broader than the width of and higher than the device-side selection protrusion. As a result, the invention is geared so that no insertion is carried out with parts other than the reference groove 30 even if the user tries to connect these unconsciously. As a result, valve 7 does not open when connection is not complete.

In addition, reference groove 30 is made longer than selection groove 31 and the device-side selection protrusion is formed at a position whereby it interlocks with the cartridge-side selection groove 31 at mid-point when the cylindrical body 20 is inserted. As a result, only the reference groove 30 is inserted so that the fuel cartridge in which different types of fuel are stored is such that only the reference groove is inserted at mid-point. It is not installed on the device and the fuel supply opening does not open thereby ensuring safety.

As a result, even if the user starts to install a fuel cartridge in which different type of fuel are stored erroneously, only the reference groove 30 will be inserted at midpoint.

FIG. 3 is an inclined view of a second mode of working of the present invention. A reference groove 40—which extends from the end of the cylindrical body 20 in the insertion direction of the cylindrical body 20—is formed at a single location on the inside periphery of the cylindrical body 20. In addition, a single selection groove 41 which is shorter than the reference groove 40 is formed at a preset position according to the type of fuel used.

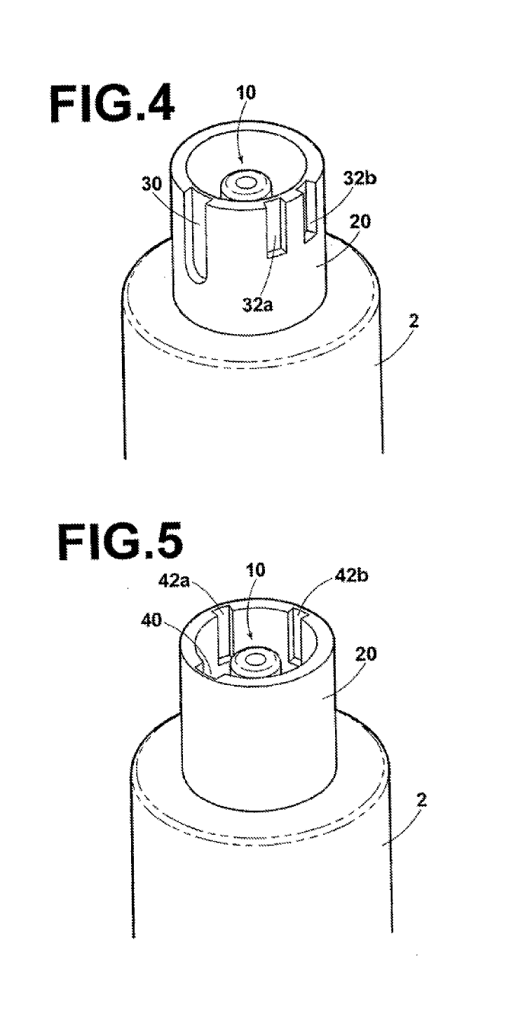

FIG. 4 is an inclined view of a third mode of working of the present invention. A reference groove 30—which extends from the end of the cylindrical body 20 in the installation direction of the cylindrical body 20—is formed at a single location on the outside periphery of the cylindrical body 20. Two selection grooves 32a and 32b which are shorter than the reference groove 30 are formed at a preset position in accordance with the type of fuel used.

FIG. 5 is an inclined view of a fourth mode of working of the present invention. A reference groove 40—which extends from the end of the cylindrical body 20 in the installation direction of the cylindrical body 20—is formed at a single location on the inside periphery of the cylindrical body 20. Two selection grooves 42a and 42b which are shorter than the reference groove 40 are formed at a preset position according to the type of fuel used.

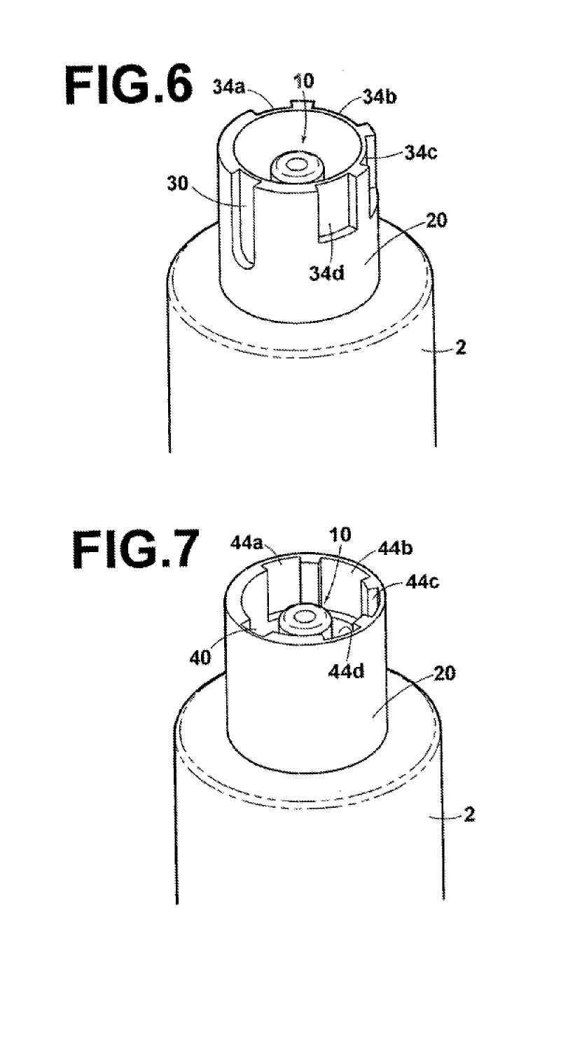

FIG. 6 is an inclined view of a fifth mode of working of the present invention. A reference groove 30—which extends from the end of the cylindrical body 20 in the installation direction of the cylindrical body 20—is formed at a single location on the outside periphery of the cylindrical body 20. Four selection grooves 34a, 34b, 34c and 34d which are shorter and comparatively wider than the reference groove 30 are formed at a preset location according to the type of fuel used.

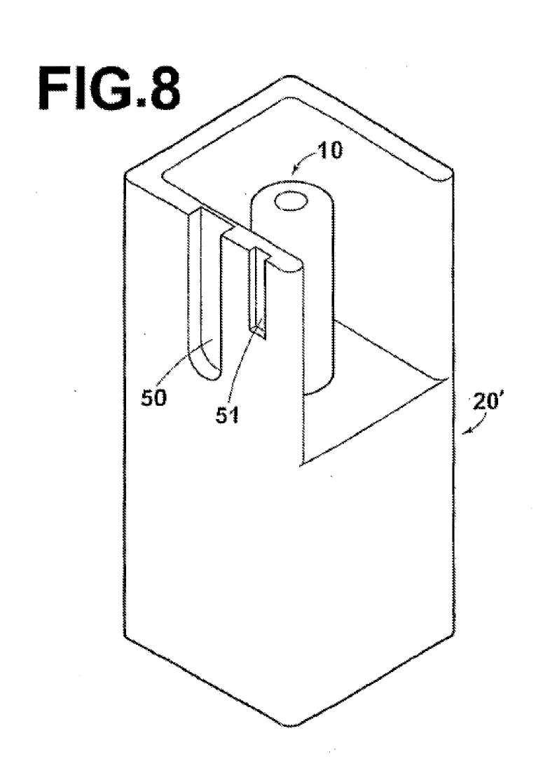

FIG. 7 is an inclined view of a sixth mode of working of the present invention. A reference groove 40—which extends from the end of the cylindrical body 20 in the installation direction of the cylindrical body 20—is formed at a single location on the inside periphery of the cylindrical body 20. Four selection grooves 44a, 44b, 44c and 44d which are shorter and comparatively wider than the reference groove 40 are formed at a preset position according to the type of fuel used.

Furthermore, in the aforementioned modes of working of the invention, only one reference groove 30 or 40 is disposed for positioning use. However, multiple reference grooves may be disposed at a point symmetric position relative to the center of the cylindrical body. In this case, the selection groove too was formed at a point symmetric position. In addition, the selection groove may be disposed on both the outside periphery and the inside periphery of the cylindrical body. A large number of combination patterns may be used which change the width and/or the position of the selection groove.

In addition, in the aforementioned modes of working of the invention, the selection grooves were disposed on the inside and outside peripheries of the cylindrical bodies 20 to provide some variation in the shape of the cylindrical body 20. However, the choice is not limited to grooves and protrusions may be used as well. The diameter of the cylindrical body 20 may be changed according to the type of fuel used.

In the aforementioned workings of the invention, the cylindrical body 20 was used as a connection protruding body. However, the choice is not limited to this and a reference groove 50 and a selection groove 51 may be disposed on the outside periphery of the protruding body 20′, which has a sectional shape resembling a rectangle with the left-hand side removed.

In the workings of the invention indicated above, the shape of the protruding body was varied according to the type of fuel used. A fuel cartridge which stores types of fuels which are different from those [in the present invention] may be used to prevent the fuel cartridge from being erroneously installed. In addition, the same color may be placed on at least the device side and the cartridge for different types of fuels so that they can be easily identified.

### INDUSTRIAL APPLICABILITY

As indicated above, the connection structure of the fuel cartridge for fuel cell in the present invention is suitable for preventing erroneous installation on devices of fuel cartridges which store different types of fuels supplied to fuel cells used as a small-scale power source for portable personal computers (notebook computers, PDAs and the like).

1. A connection structure for fuel cartridge for fuel cell which is used to connect a fuel cell cartridge having (a) a container main body which itself is provided with (i) a fuel supply opening which is used to supply fuel and (ii) a connection protruding body which surrounds said fuel supply opening; and (b) a fuel storage chamber which is formed inside the aforementioned container main body which is used to store the fuel supplied to the fuel cell; and
a fuel cell device which is provided with a connection part corresponding to the aforementioned connection protruding body; the invention characterized as having
a reference protrusion or reference groove which is the standard for the absolute position which is formed on the aforementioned connection protruding body and one or more selection protrusions or selection grooves which are formed at a position which is relatively different according to the type of fuel mentioned previously relative to said reference protrusion
a device-side reference groove or device-side reference protrusion corresponding to the aforementioned reference protrusion or reference groove and a device-side selection groove or device-side selection protrusion which corresponds to the aforementioned selection protrusion or selection groove are formed on the connection part of the aforementioned fuel cell device,
and it is configured so that only when the aforementioned reference protrusion or reference groove interlocks with the aforementioned device-side reference groove or device-side reference protrusion and the aforementioned selection protrusion or selection groove on the aforementioned connection use protruding body interlocks with the device-side selection protrusion is the aforementioned fuel cartridge inserted as far as the indicated position where the aforementioned fuel supply opening opens;

2. The composition of claim 1 wherein the aforementioned reference protrusion or reference groove is longer than the aforementioned selection protrusion or selection groove;

3. The composition of claim 1 wherein the aforementioned reference protrusion or reference groove is wider than the aforementioned selection protrusion or selection groove;

4. The composition of claim 1 wherein the aforementioned reference protrusion or reference groove is deeper than the aforementioned selection protrusion or selection groove;

5. The composition of claim 1 wherein different colors are provided to at least part of the aforementioned fuel cartridge and at least part of the aforementioned fuel cell device depending on the type of fuel used;

6. A fuel cartridge for fuel cell which is provided with (a) a container main body which itself is provided with (i) a fuel supply opening which is used to supply fuel and (ii) a connection protrusion which surrounds said fuel supply opening; and (b) a fuel storage chamber which is formed on the inside of the aforementioned container main body which is used to store the fuel supplied to the fuel cell; said fuel cartridge for fuel cell characterized as having a reference protrusion or reference groove which is the standard at an absolute position which is formed on the aforementioned connection protrusion; and one or more selection protrusions or selection grooves are formed at relatively different positions in accordance with the type of fuel mentioned previously relative to said reference protrusion or reference groove;

7. The composition of claim 6 wherein the aforementioned reference protrusion or reference groove is longer than the aforementioned selection protrusion or selection groove;

8. The composition of claim 6 wherein the aforementioned reference protrusion or reference groove is wider than the aforementioned selection protrusion or the aforementioned selection groove;

9. The composition of claim 6 wherein the aforementioned reference protrusion or reference groove is longer than the aforementioned selection protrusion or the aforementioned selection groove.
